(19) United States
(12) Patent Application Publication
(10) Pub. No.: US 2026/0188895 A1
(43) Pub. Date: Jul. 2, 2026

(54) IMPEDANCE ADAPTATION DEVICE FOR A LOW-PROFILE SATELLITE ANTENNA

(71) Applicant: HI-TE S.R.L., Goro (IT)

(72) Inventors: Enrico Ghezzo, Goro (IT); Antonello Giovannelli, Goro (IT)

(21) Appl. No.: 18/802,135

(22) PCT Filed: Apr. 6, 2023
(86) PCT No.: PCT/IB2023/053524

§ 371 Date: Aug. 13, 2024

(30) Foreign Application Priority Data
Apr. 6, 2022 (IT) 102022000006866

(51) Int. Cl. H01Q 1/32; H01Q 9/16; H01Q 9/44

(52) U.S. Cl. CPC H01Q 1/3275; H01Q 9/16; H01Q 9/44

(57) ABSTRACT

The device (100) adapts the impedance of a low-profile satellite antenna (1), placed on the roof (T) of a vehicle (V). The satellite antenna (1) comprises a radiating assembly comprising four dipoles (2), and an adapting circuit. According to the invention, the device (100) comprises: a metallic cross-shaped element (20), arranged on a raised plane relative to that on which said four dipoles (2) lie, with each spoke (22) of said cross element (20) arranged aligned with respect to the corresponding underlying dipole (2); electrical connection means (23), interposed between the end of each spoke (22) of said cross-shaped element (20) and an intermediate point of the corresponding underlying dipole (2). In this way, the intermediate points of the said four dipoles (2) are electrically interconnected, short-circuited, through said metallic cross-shaped element (20). Through the device (100), the performance of the satellite antenna (1) is significantly improved.

### TECHNICAL FIELD

The present invention belongs to the technical field of radio frequency telecommunications.

In particular, the invention relates to a device capable of adapting the impedance in a satellite antenna intended, primarily but not exclusively, for mobile use, i.e. applied to an external surface of vehicles of any kind, whether self-propelled or towed. For example, the antenna of the invention is applied to the roof of land, sea, or air vehicles equipped with transceiver radios, configured so as to conveniently reduce their footprint in the horizontal direction.

For illustrative and non-limiting purposes in the following, the invention will be described in its use on a military land vehicle. It is understood that additional applications beyond those listed above are to be considered within the scope of the invention.

### BACKGROUND ART

As is well known, satellite communications, both in the civilian and military fields, take advantage of the availability of “bridging” satellites to extend the range of radiocommunication systems which are mobile or otherwise distributed over the territory.

For this purpose, according to known techniques, the aforementioned radiocommunication systems are provided with satellite transceivers (“SATCOMs”) properly piloted and connected to other transceiver equipment and served by dedicated antennas.

Satellite radiocommunications equipment includes antennas normally having an omnidirectional radiation pattern, in the horizontal plane, and a circular polarization coordinated with the rotation direction of that from the antenna placed on board the satellite.

Satellite antennas of this type are often of the crossed dipole type, that is, they comprise two crossed stems arranged in the same horizontal plane and electrically connected in such a way as to be 90° electrically out of phase, and thus obtain the necessary circular polarization.

Mounting said satellite antennas on vehicles essentially requires containing their size and dimensions, seeking the best compromise with the necessary maintenance of a high standard of efficiency.

In particular, one must mediate with regard to the distance in height between the dipoles of the antenna and the part of the body to which the antenna is attached, where the performance of the antenna would require a high projection, while the protection of the safety of the antenna itself from collisions against fixed obstacles, encountered when the vehicle is in motion, would recommend a projection as small as possible.

In addition, for military applications, the immediate recognizability of a satellite antenna on board a vehicle, making the vehicle's function equally identifiable, is considered a strong negative aspect, for obvious reasons.

The same Applicant, for the purpose of obtaining a satellite antenna with low visual impact, protected from shocks caused by obstacles as well as effectively camouflaged, has filed patent application for industrial invention under No. 102018000009026 entitled “Low Profile Satellite Antenna for Mobile Radio Communication,” in which a satellite antenna comprises: four radiating elements arranged radially and crossed at 90°, forming a double dipole configuration;
a support assembly for said radiating elements, formed in such a way that the latter are on a nearly horizontal plane, located elevated by a predetermined, suitably limited height above the roof of the vehicle on which the satellite antenna is installed;
a flattened box-shaped enclosure intended to house the said support assembly and associated radiating elements, making them invisible from the outside;
attachment means, associated with said box-shaped enclosure, provided to enable the latter to be removably locked to said vehicle roof. Advantageously, the outer ends of the radiating elements are bent downward, improving the transmissive/receptive characteristics of the antenna.

### Technical Problem

In practical experimentation, excessive impedance reduction was found at the main RF power connection, compared with the theoretical 75 Ohms: this effect is caused by the width of the radiating elements, their proximity to the metal mass plane of the body, and the presence of the bent fins at the ends of these radiating elements.

### OBJECTS OF THE INVENTION

The object of the present invention is to propose a device for adapting the impedance of a low-profile satellite antenna, which is capable of performing its function even in the presence of the aforementioned conditions of construction and installation of the antenna.

Another object of the invention is to make a device that is simple, easy to apply, and does not significantly increase the antenna's height footprint, such that the corresponding box-like housing is not to be modified.

Still another object of the invention is to make a device that does not require its own power supply, and therefore does not increase the complexity of the transceiver radio system and/or its installation in the vehicle.

A further object of the invention is to obtain a device that can also be easily applied to existing satellite antennas, so as to increase their performance.

### SUMMARY OF THE INVENTION

These and other objects are fully achieved by means of a device for adapting the impedance of a low-profile satellite antenna, with the latter intended to be placed on the roof or other part of the bodywork of a vehicle equipped for radio communications, and to be radio-frequency powered by a transmitter device, said satellite antenna being of the type comprising a radiating assembly formed by four radiating elements having an elongated planar conformation and arranged in an orthogonal radial pattern so as to define a pair of crossed dipoles, and an adaptor circuit, suitable for feeding said radiating assembly with a 90° electrical phase shift.

The above device comprises:
a metal cross-shaped element, disposed in a plane parallel and situated at a predetermined elevation above that on which said four radiating elements lie, with each spoke of said cross-shaped element arranged substantially aligned with respect to the corresponding underlying dipole;
electrical connection means, interposed between the end of each spoke of said cross-shaped element and an intermediate point of the corresponding underlying radiating element, so that the intermediate points of said four radiating elements are electrically interconnected and short-circuited through said metallic cross-shaped element, thereby resulting in an increase in the impedance value at the main radio frequency feed connection of said satellite antenna.

### BRIEF DESCRIPTION OF THE DRAWINGS

The features of the subject invention will be evident from the following description of a preferred embodiment of the device for adapting the impedance of a low-profile satellite antenna, in accordance with what is proposed in the claims and with the aid of the attached drawings, in which:

FIG. 1 illustrates an axonometric view of a cross-dipole radiating assembly of a satellite antenna, with the device subject of the invention associated with it;

FIGS. 1A, 1B and 1C schematically illustrate as many known dipole configurations of a satellite antenna cross-dipole radiating assembly;

FIG. 1D schematically illustrates the dipole configuration of a cross-dipole radiating assembly of the antenna according to the invention;

FIG. 2 illustrates a schematic side view of a satellite antenna equipped with the device, housed in a box-like enclosure and attached to the roof of a vehicle;

FIG. 3 illustrates a plan view of FIG. 2, with the top of the enclosure removed to better highlight the interior;

FIGS. 4 and 5 illustrate graphs inherent in the electrical characteristics of a satellite antenna without the device;

FIGS. 6 and 7 illustrate the same graphs as in FIGS. 4 and 5 with the electrical characteristics obtained by applying the device to the satellite antenna, to better highlight the performance gains.

### DESCRIPTION OF PREFERRED OF EMBODIMENTS OF THE INVENTION

In the above figures, a low-profile satellite antenna has been indicated by reference 1, for which the impedance adapting device which is the subject of the invention is intended, itself indicated, as a whole, by reference 100.

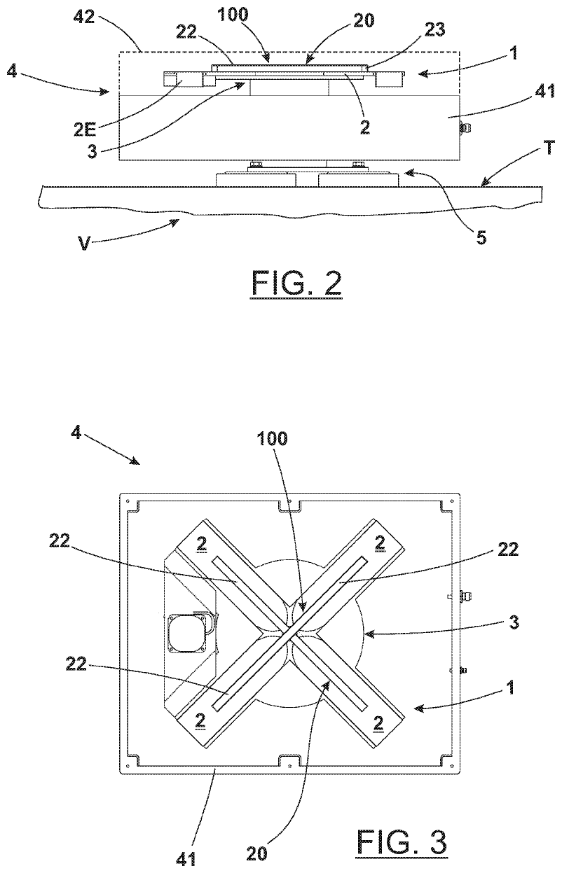

The satellite antenna 1 is, for example, of the type described in the patent application of the same Applicant mentioned in the introduction statement and is intended to be placed on the roof T of a vehicle V equipped for radio communications (partially illustrated in FIG. 2), or on another external surface thereof.

In a manner per se known, said satellite antenna 1 comprises a radiating assembly formed by four radiating elements 2 having elongated planar conformation, arranged in an orthogonal radial pattern to define a pair of crossed dipoles.

The radiating elements 2 have their respective outer end portions 2E bent downward, for the same reasons specified in the aforementioned previous patent application.

Also, in a known way, the radiating elements 2 of the radiating assembly are constrained to a central support assembly 3 and the whole is housed in a flattened box-like casing 4 for effective camouflage of the satellite antenna 1.

The box-like casing 4 is provided with suitable attachment means 5, e.g., suction or magnetic cups, provided to enable the same to be removably locked to the aforementioned roof T of the vehicle V.

The box-like casing 4 is made of two half-shells, a lower 41 and an upper 42 shell respectively, with material having dielectric properties and can be opened.

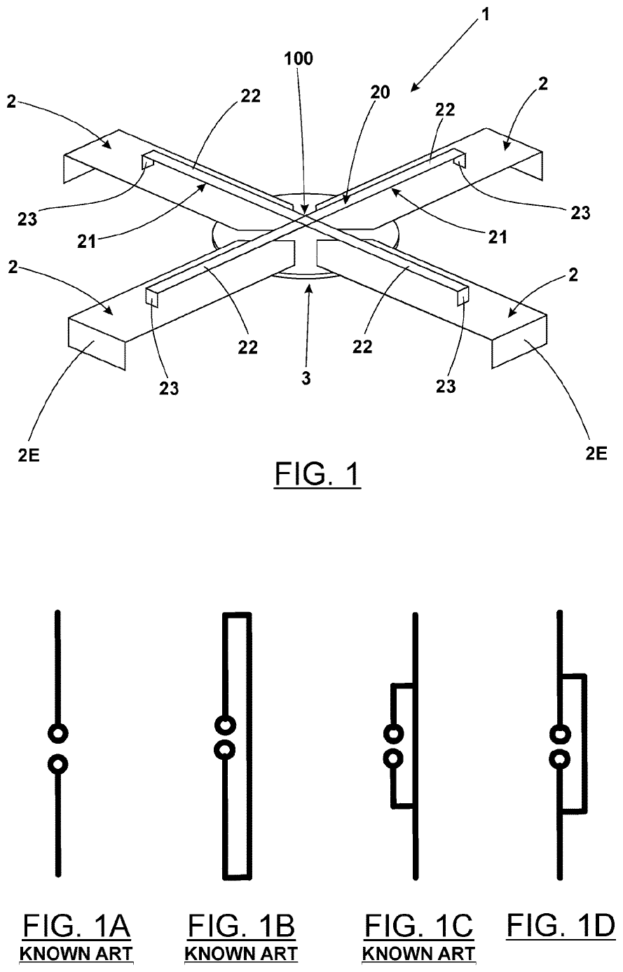

According to the invention, the device 100 (see especially FIG. 1) is attached to the satellite antenna 1, which consists of:
a metal cross-shaped element 20, disposed in a plane parallel and situated at a predetermined elevation above that on which said four radiating elements 2 lie, with each spoke 22 of said cross-shaped element 20 arranged substantially aligned with respect to the corresponding underlying radiating element 2;
electrical connection means 23, interposed between the end of each spoke 22 of said cross-shaped element 20 and an intermediate point of the corresponding underlying radiating element 2, so that the intermediate points of said four radiating elements 2 are electrically interconnected and short-circuited through said metallic cross-shaped element 20, thereby resulting in an increase in the impedance value at the main radio frequency feed connection of said satellite antenna 1.

In the preferred embodiment here illustrated, the metal cross-shaped element 20 is made from two pieces of a flat band 21, overlapping, crossed at 90° and joined in the center, so that the said four spokes 22, thus defined, have equal length.

Alternatively, it is possible to provide that said cross metal element 20 be made by means of four pieces of said flat band 21, arranged at 90° to each other and joined in the center, again so that the said four spokes 22, thus defined, have equal length (this variant is not illustrated as it is of intuitive understanding).

Advantageously, for both of the proposed solutions, it is contemplated that said electrical connection means 23 are defined by portions of the same pieces, bent downwardly from the ends of said spokes 22 until they touch the underlying radiating elements 2.

As already described in the aforementioned prior patent application on behalf of the same Applicant, the radiating elements 2 have their surface arranged substantially parallel to the surface of the vehicle (e.g., roof T) on which the antenna 1 is positioned, and are connected to a hybrid splitter with electrical 90° phase shift; the latter has two ports with 50 Ohm characteristic impedance, which are 90° electrically offset from each other, to which the two dipoles are connected, and a third port with 50 Ohm characteristic impedance that allows connection to the antenna port of the transceiver, appropriately combining the signals from the two dipoles.

In general, as is well known, the impedance that a dipole presents at the feed port depends on the voltage to current ratio at the point where the port is located, i.e., the two conductors carrying RF power to the dipole. If the dipole is fed at the centre (see the diagram in FIG. 1A), the characteristic impedance turns out to be about 75 Ohms, whereas if it is fed at the extremities (the case of the “folded” dipole, FIG. 1B), the impedance increases to about 300 Ohms. In general, if power is applied to two intermediate points (FIG. 1C), the impedance will have an intermediate value between 75 and 300 Ohms.

In particular, compared with the conventional dipole of FIG. 1C with intermediate-socket, in which the feed port is placed on the pair of conductors directed to an intermediate point of the “main arm,” the dipole according to the present invention (FIG. 1D) has the feed port on the “main arm,” and a short-circuit line between two intermediate and mirrored points of the “main arm”.

In this way, the impedance at the power port comes to depend on the position of the short-circuit application points on the main arm, the width and thickness of the strip with which the short-circuit conductor is made, and its distance from the “main arm”.

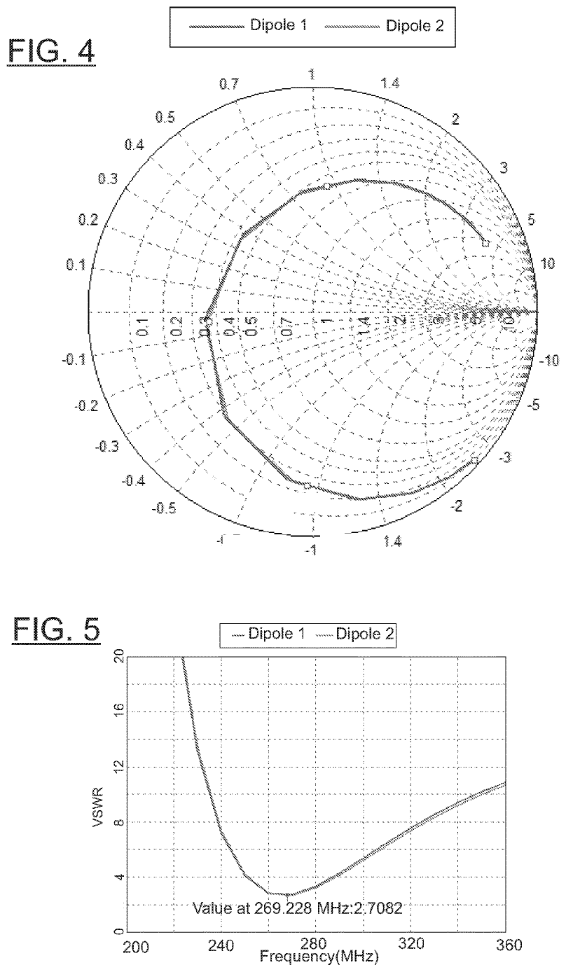

FIGS. 4 and 5 show the trends of the impedances of the two dipoles in the absence of the device 100 referred to in the present invention: they show that the impedance of the two dipoles is approximately 15 Ohm (FIG. 4), while the SWR (reflection coefficient) curve has a value of 2.71:1 (FIG. 5).

These values do not reflect what is expected to achieve the best performance of satellite antenna 1: in fact, as is well known to experts in the field, the performance of an antenna in terms of impedance matching with the source, and thus power and efficiency transfer, is all the better as the value of SWR, i.e., the reflection coefficient, is lower.

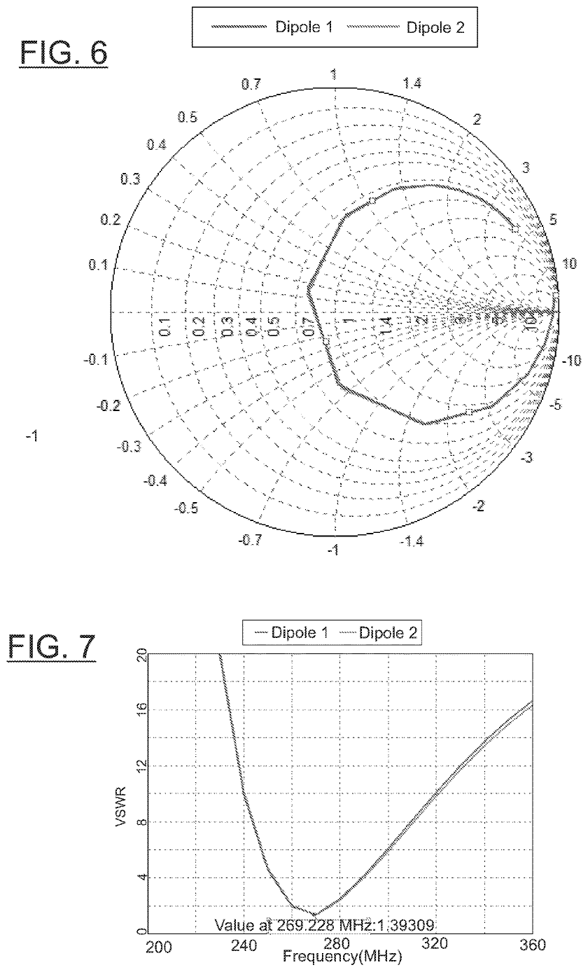

FIGS. 6 and 7, on the other hand, show the impedance trends of the two dipoles 2 when device 100 is applied as specified.

From the comparative analysis of FIGS. 6 and 7, with respect to FIGS. 4 and 5, the significant improvement is evident, where the impedance of the two dipoles reaches approximately 50 Ohms (FIG. 6), while the SWR (reflection coefficient) curve takes on a value of 1.39:1 (FIG. 7).

What has been stated is explained by the fact that the phase of the voltages present at the aforementioned intermediate points is opposite to the pairs of radiating elements 2, and therefore a voltage null value is established at a point exactly in the middle (i.e., where the spokes 22 of the cross-shaped element 20 meet), therefore a “short circuit” can be produced, represented by the center of that cross.

This feature makes it possible to advantageously increase the impedance value at the main RF power connection, so compensating for the otherwise too small impedance value compared to the theoretical 75 Ohms due to the width of the radiating elements 2, the proximity to the ground plane, and the presence of the bent outer terminal parts 2E.

From what is said above, experts in the field are in a position to knowingly evaluate, and consequently appreciate, the significant improvements achievable with the simple device covered by the present invention.

In order to evaluate even better the advantages of the invention, it is useful to point out that the proposed device can perform its function while having the same manufacturing and installation conditions as the satellite antenna, particularly with regard to the distance from the surface of the vehicle body and the fact that a containment casing is provided.

Except for the functional aspect of the device, anyone is able to grasp the fact that this is extremely simple and easy to apply, therefore realizable with a very low cost; moreover, the almost nil increase in the height of the antenna is emphasized, such that the corresponding box-like casing need not be modified.

It is also important to mention that the proposed device does not require its own power supply, and therefore does not complicate the transceiver radio system and/or its installation in the vehicle at all.

It is intuitive to understand that the device can be applied easily, and with very limited costs, even on existing satellite antennas, so as to increase their performance.

However, it is understood that what is described above is illustrative and not limiting, therefore any detail variations that may be necessary for technical and/or functional reasons are considered from now on within the same protection scope defined by the claims below.

1. Impedance adaptation device for a low-profile satellite antenna configured for placement on a roof (T) or other part of a body of a vehicle (V) equipped with a communication apparatus, with said satellite antenna (1) energizable with radio-frequency power by a transceiver device and comprising a radiating unit consisting of four radiating elements (2) having an elongated planar conformation and arranged in an orthogonal radial pattern to define a pair of crossed dipoles, and an adaptor circuit, that energizes said radiating unit with a 90° electrical phase shift, said device (100) comprising:
a metallic cross-shaped element (20) with four spokes (22), situated in a plane located at predetermined height above, and parallel to, a plane that said four radiating elements (2) lie in, with each spoke (22) of said cross-shaped element (20) disposed substantially aligned with respect to a corresponding underlying radiating element (2); and
electrical connection means (23), interposed between an end of each spoke (22) of said cross-shaped element (20) and an intermediate point of a corresponding underlying radiating element (2), such that corresponding intermediate points of said four radiating elements (2) are electrically interconnected, in short circuit, through said metallic cross-shaped element (20), so as to cause an increase of an impedance value a main radio frequency feed connection of said satellite antenna (1).

2. The impedance adaptation device according to claim 1, wherein said metallic cross-shaped element (20) consists of two pieces of a flat strip (21), superimposed, crossed at 90° and joined at a center, so that the four spokes (22) have equal lengths, and in that wherein said electrical connection means (23) are defined by portions of said strips, bent downwards starting from the end of each spoke (22) until touching the corresponding underlying radiating element (2).

3. The impedance adaptation device according to claim 1, wherein said metallic cross-shaped element (20) is made from pieces of a flat metallic strip (21), placed at 90° from each other and joined in a center, so that the four spokes (22) have equal lengths.
